(19) United States
(12) Patent Application Publication
(10) Pub. No.: US 2024/0278713 A1
(43) Pub. Date: Aug. 22, 2024

(54) Vehicle Sign Device

(71) Applicant: Horace Walker, JR., Tampa, FL (US)

(72) Inventor: Horace Walker, JR., Tampa, FL (US)

(21) Appl. No.: 18/649,675

(22) Filed: Apr. 29, 2024

Related U.S. Application Data
(63) Continuation-in-part of application No. 29/936,595, filed on Apr. 9, 2024.
(63) Continuation-in-part of application No. 29/757,120, filed on Nov. 3, 2020, now Pat. No. D034268.
(60) Provisional application No. 63/503,261, filed on May 19, 2023.

(51) Int. Cl. B60Q 1/36; B60Q 1/34; B60Q 1/40

(52) U.S. Cl. CPC B60Q 1/36; B60Q 1/346; B60Q 1/40

(57) ABSTRACT

The vehicle sign device is intended to provide users with a signaling device that allows vehicle drivers to better alert oncoming vehicles of the intention to turn right. The device is an easy-to-install, portable, convenient, and retractable sign device designed to make it easy to send a clear safety message to nearby drivers. To accomplish this, the device includes an axially rotatable sign member attached to the vehicle with the help of a mounting member. The mounting member includes an actuator assembly to control the motion of the sign member both wirelessly and manually. Further, the device includes a plurality of lighting members integrated onto the sign member that progressively flashes and helps in gaining better attention from nearby drivers. Furthermore, the sign member has caution signal labels that are backlit for efficiently communicating caution. Thus, the device is a more visible way to warn other drivers quickly and efficiently.

### FIELD OF THE INVENTION

The present invention generally relates to a traffic sign device. More specifically, the present invention relates to an apparatus that extends a yield sign (or other notifying sign) on the side of a vehicle.

### BACKGROUND OF THE INVENTION

A sign device that allows a vehicle driver, especially a driver of a large vehicle, such as a trailer, a van, a truck, etc. to warn oncoming vehicles of the intention to turn right is in demand. Driving around commercial trucks can be very dangerous, requiring drivers to take extra precautions. These vehicles, which are generally larger than normal passenger vehicles, are at higher risk of an accident because they have larger blind spots, cannot maneuver as easily, and take longer to stop compared to normal passenger vehicles.

Generally, semi-trailer trucks require more room than passenger vehicles to make turns, and different-sized vehicles follow a different path when they make turns. Large commercial trucks can have large blind spots, poor maneuverability, longer stop times, and they require extra room for turns, making them extremely dangerous for other drivers.

A vehicle, because of its large size or structure, may need to swing left to gain room for a right turn; in some situations, it may need to start a turn from the middle lane of traffic. Accordingly, drivers, especially when stopped at an intersection, must make sure their vehicle is maintaining a safe distance around any large vehicle.

Truck drivers may use “wide turns” signs and labels to help ensure that other drivers give their trucks enough room to turn safely, protecting the other drivers and their vehicles.

Companies are manufacturing wide-turns signs and labels in a variety of sizes, colors, styles, and materials to send a clear vehicle safety message to nearby drivers. However, frequently, these signs and labels are ineffective, difficult to install, not portable, or include inconvenient designs for carrying. Thus, there is a need to develop a device to solve these problems.

The present invention is intended to address problems associated with and/or otherwise improve on conventional devices through an innovative sign device designed to provide a convenient means to install and send a clear safety message to neighboring drivers located near the user's vehicle while incorporating other problem-solving features.

### SUMMARY OF THE INVENTION

The vehicle sign device is intended to provide users with a signaling device that allows drivers to better alert oncoming vehicles of the intention to turn right. The present invention is an easy-to-install, portable, convenient, and retractable sign device designed to make it easy to send a clear safety message to nearby drivers. To accomplish this, the present invention comprises an axially rotatable sign member attached to the vehicle with the help of a mounting member. The mounting member further includes an actuator assembly to control the motion of the sign member both wirelessly and manually. Further, the present invention comprises a plurality of lighting members integrated onto the sign member that progressively flashes and helps in gaining better attention from nearby drivers. Furthermore, the present invention has caution signal labels that are backlit for efficiently communicating caution. Thus, the present invention is a more visible way to warn other drivers quickly and efficiently.

### BRIEF DESCRIPTION OF THE DRAWINGS

FIG. 1 is a top-rear-right perspective view of the present invention.

FIG. 2 is a bottom-rear-left perspective view of the present invention.

FIG. 3 is a front perspective view of the present invention, wherein the sign member is in a retracted configuration.

FIG. 4 is a top plan view of the present invention.

FIG. 5 is a bottom-front-left perspective view of present invention.

FIG. 6 is a top front right perspective view of the present invention, wherein the sign member is in a deployed configuration.

FIG. 7 is a bottom front left perspective view of the present invention in deployed configuration.

FIG. 8 is a bottom plan view of the present invention.

FIG. 9 is a system diagram of the actuator assembly, wherein thinner lines represent electrical connection, thicker lines represent electronic connection, and broken lines represent communicable connection between components of the present invention.

FIG. 10 is a schematic diagram of the side view of a large vehicle, wherein the sign device is mounted onto a lateral side of the vehicle, and the sign member is in a retracted configuration.

FIG. 11 is a schematic diagram of the rear view of a vehicle, wherein the sign device is mounted onto a lateral side of the vehicle, and the sign member is in a deployed configuration.

### DETAIL DESCRIPTIONS OF THE INVENTION

All illustrations of the drawings are for the purpose of describing selected versions of the present invention and are not intended to limit the scope of the present invention.

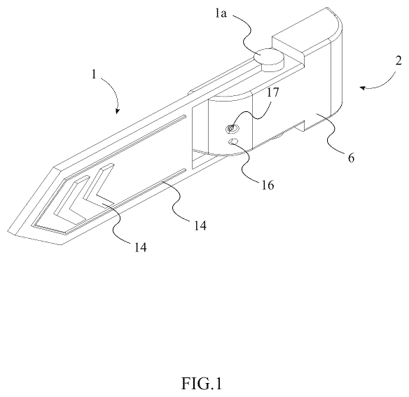

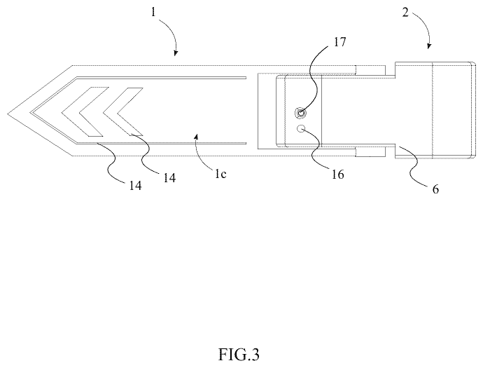

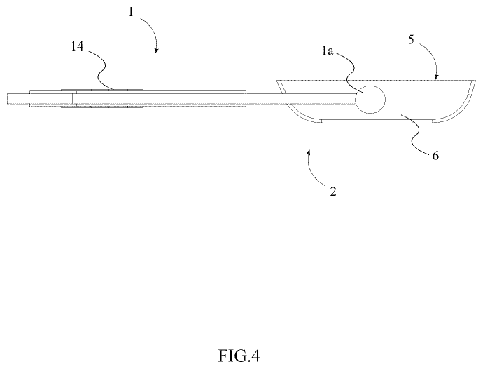

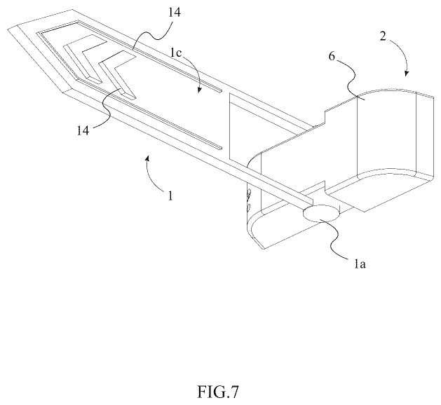

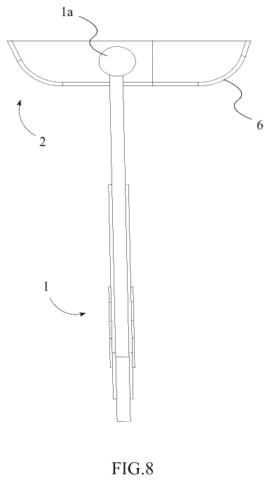

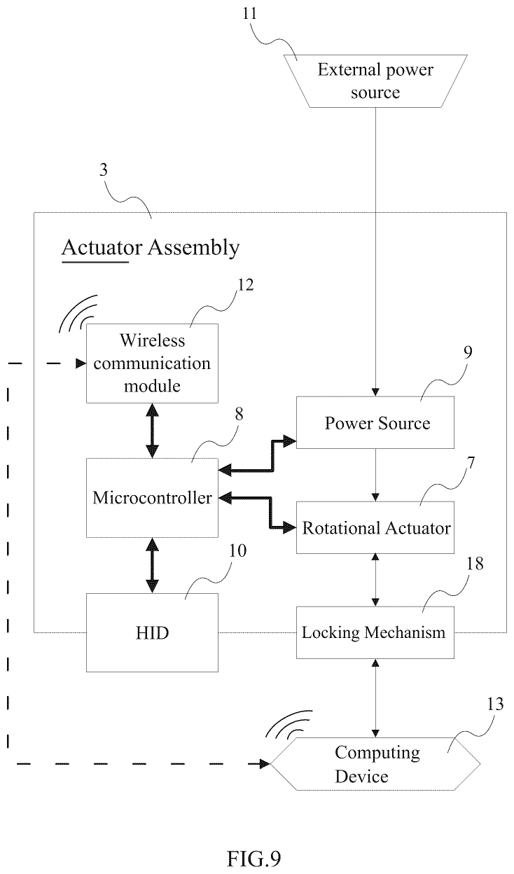

In reference to FIG. 1 through FIG. 11, the present invention is a vehicle sign device. The present invention is an easy-to-install, portable, convenient, and retractable sign device designed to make it easy to send a clear safety message to nearby drivers.

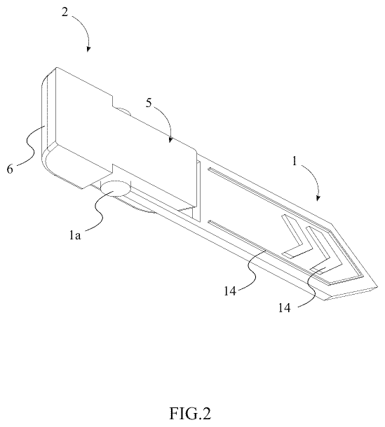

The following description is in reference to FIG. 1 through FIG. 11. According to a preferred embodiment, the present invention comprises a sign member 1, a mounting member 2, an actuator assembly 3, and a vehicle 4. The sign member 1, as shown in FIG. 1 and FIG. 2, can be any conventional sign indicating or capable of sending warning that a vehicle is about to turn, including a “Yield” sign. The sign member 1 can be of any suitable size and shape, such as a polygon or a triangle, and made of any material suitable to be installed or carried outside a vehicle, such as steel or any light metal. Further, the sign member 1 comprise a connecting member 1a that connects the sign member 1 to the actuator assembly 3. However, the sign member 1 may comprise any other connecting members such as a rod, frame, or structure made of a plurality of links, etc.

According to the preferred embodiment, the mounting member 2 may be configured to attach the sign member 1 to the body of the vehicle 4. The mounting member 2 may include a structure or design that allows the sign device of the present invention to be secured in any desired place on the vehicle 4. Further, the sign device or the mounting member 2 may be mounted onto any vehicle, examples of which include, but not limited to, refrigerated van trailer, dry van trailer, tankers trailer, etc., and onto any location or surface of the vehicle 4, as long as the intents of the present invention are fulfilled. As seen in FIG. 1 through FIG. 8, the mounting member 2 comprises a mounting surface 5 and a casing 6. The mounting surface 5 is the surface that attaches to the body of the vehicle 4. Preferably, the sign member 1 is axially connected to the mounting member 2, and the mounting member 2 is laterally mounted onto the vehicle 4 along the mounting surface 5. Further, the actuator assembly 3 is mounted within the casing 6. In other words, the casing 6 and the mounting surface 5 together, or the mounting member 2 act as a housing for the actuator assembly 3. In an alternate embodiment, the actuator assembly 3 may include a separate outer box-shaped housing for providing a tamper-proof and weatherproof environment for the internal components that may be included in the actuator assembly 3.

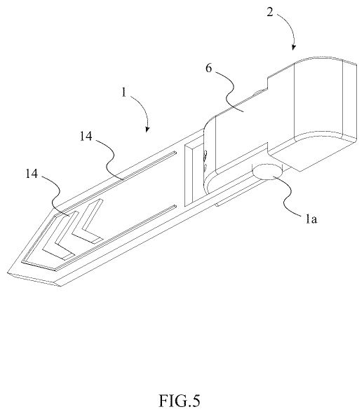

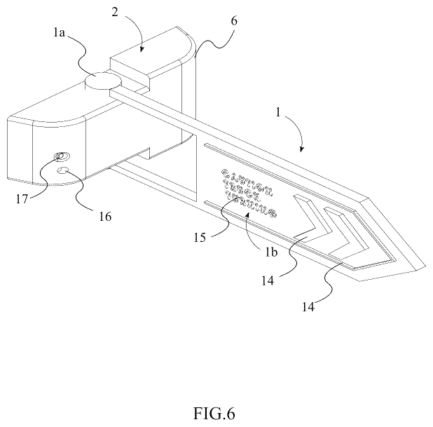

The actuator assembly 3 is operably integrated between the mounting member 2 and the sign member 1, wherein operating the actuator assembly 3 governs axial rotation of the sign member 1 between a retracted configuration and a deployed configuration. In other words, the mounting member 2 includes an actuator assembly 3 configured to pivot the sign member 1, as shown in FIG. 5 and FIG. 6, between a retracted (stored) position adjacent to the side of the vehicle 4 and an extended (deployed) position wherein the sign member 1 extends outward from the vehicle's 4 (truck, van, trailer) side at an appropriate angle, which can range from about zero to ninety degrees.

A more detailed description of the present invention follows. According to the preferred embodiment, the actuator assembly 3 comprises a rotational actuator 7, a micro controller 8, a power source 9, and a HID (human interface device) 10. The rotational actuator 7 may be a servomotor or any similar rotary actuator that allows for precise control of the angular position, velocity, and acceleration. The rotational actuator 7 may comprise a bidirectional or reversible electric motor that drives an output shaft via a speed-reducing gear set, where the output shaft is accessible via a hole that may be included in the wall of the casing 6. However, it should be noted that the rotational actuator 7 may comprise any brand, size, technology, components, arrangement of components etc. that are known to one of ordinary skill in the art, as long as the intents of the present invention are not altered.

Preferably, the rotational actuator 7 and the HID 10 are electronically coupled to the microcontroller 8. The microcontroller 8 is a processing device that interprets commands received from the different components of this device and uses these commands to manage the operation of the electrical components within the present invention. More specifically, the microcontroller 8 is connected to the rotational actuator 7 for controlling the movements of the sign member 1. The human interface device (HID) 10, forms the platform for user interaction in order to perform the various operations of the present invention. Preferably, the HID 10 is a switch or a button positioned adjacent to a driver's seat of the vehicle 4, such that the driver may control the actuation and/or operations of the present invention. However, the HID 10 may comprise any other position, location, technology, etc. that are known to one of ordinary skill in the art, as long as the objectives of the present invention are not altered. Some examples of HID 10 include, but are not limited to, touch screen activation, activation through microphone, knobs/levers of various shapes, etc.

Accordingly, the rotational actuator 7 is mechanically connected to the sign member 1, such that upon receiving the deploy signal from the HID 10 through the microcontroller, the sign member 1 may be deployed or extended 90 degrees away from the vehicle surface. Alternately, the rotational actuator 7 may be electronically connected to the turn signal of the vehicle through the microcontroller 8, such that any time the driver turns on the turn indicator, the rotational actuator 7 gets an alert to actuate or rotate the sign member 1 to the deployed configuration. When the turn indicator is turned off by the driver or automatically, the sign member 1 goes back to the retracted configuration. Thus, the sign member 1 deploys and retracts in sync with the turn signal of the vehicle 4.

In order to provide electrical power to the various components of the present invention, the power source 9 is electrically connected to the microcontroller 8. Preferably, the power source 9 is a rechargeable battery, that is used to deliver electrical power to the microcontroller 8. However, any other source of power, or a combination of the following sources may be employed for the smooth functioning of the present invention. Examples of such power sources include, but are not limited to, Li ion batteries, magnetic power converters, solar power converters, etc. Further, the power source 9 may be connected to an external power source 11, such as the battery of the vehicle and/or an electrical terminal that allows the present invention to send electrical power to the microcontroller 8 and other electrical components.

In an alternate embodiment, the present invention comprises a wireless communication module 12, and a computing device 13. This is so that, the microcontroller 8 and the rotational actuator 7 may be wirelessly connected and controlled by the user's computing device 13, which may be communicatively connected to a network. In this case, users may simply control the sign device (retract or extend the sign member 1) by using their computing device 13 whenever necessary. To accomplish this, the wireless communication module 12 is electronically coupled to the microcontroller 8, and the wireless communication module 12 is communicably coupled to the computing device 13. The computing device 13 may be a laptop computer, a cellular phone, a personal digital assistant (PDA), a tablet computer, and other mobile devices of the type. Communications between components and/or devices disclosed herein may be unidirectional or bidirectional electronic communication through a wired or wireless configuration or network. For example, one component or device may be wired or networked wirelessly directly or indirectly, through a third party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type. In example embodiments, network can be configured to provide and employ 5G wireless networking features and functionalities.

It is an aim of the present invention to warn or alert oncoming vehicles of the intention of a vehicle to turn right. To better accomplish this, the sign member 1 can include one or more lights that can be flashing or blinking lights. To that end, the present invention comprises a plurality of illuminating devices 14, wherein the plurality of illuminating devices 14 is integrated onto the sign member 1. In the preferred embodiment, the plurality of illuminating devices 14 is arranged in the shape of arrows and border lines, wherein progressive flashing of the illuminating devices 14 occurs along a shape of arrows and borders. in other words, the present invention features an arrow and border that flash in a progressive pattern from left to right. This is so that the sign effectively captures the attention of other road users, thereby improving safety during turns and lane changes.

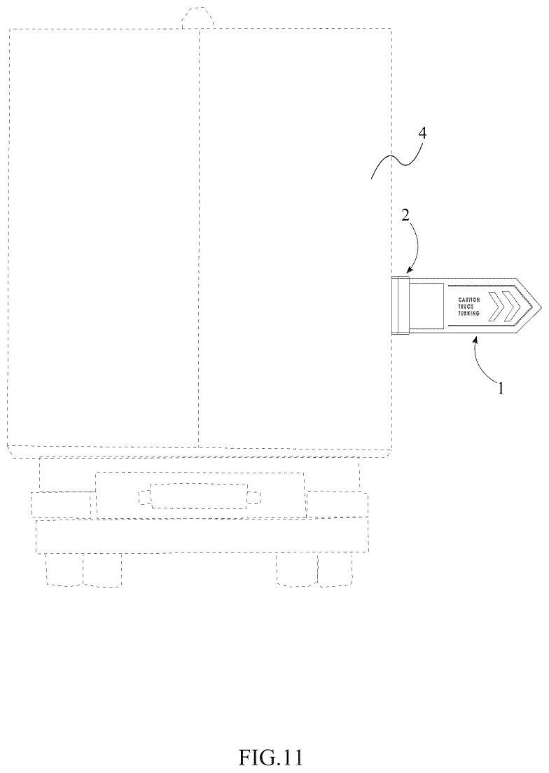

To further assist in ensuring the attention of other road users, the present invention comprises a caution label 15, wherein the caution label 15 is laterally mounted onto a first surface 1a of the sign member. As seen in FIG. 6 and FIG. 11, the caution label 15 may read signs like “CAUTION TRUCK TURNING”. Further, the caution label may be backlit for providing more visibility, ensuring clear and effective communication in various lighting conditions. However, the caution label 15 may read any other words (such as yield, give way), in any other sizes, fonts, etc., that are known to one of ordinary skill in the art, and may be positioned on both sides of the sign member 1, as long as the intents of the present invention are not altered.

Continuing with the preferred embodiment, the present invention comprises a sensor 16, and a dash camera 17, wherein the sensor 16 and the dash camera 17 are laterally integrated onto the mounting member 2. In other words, the present invention is equipped with a built-in blind spot dash cam and a proximity sensor, for enhancing driver awareness and safety on the road. To that end, the sensor 16 and the dash camera 17 are electronically coupled to the microcontroller 8. It should be noted that the sensor 16 and the dash camera 17 may comprise any brand, number, size, technology, etc. that are known to one of ordinary skill in the art, as long as the intents of the present invention are not altered.

According to the preferred embodiment, the sign member 1 may further be deployed manually. In some embodiments the present invention may comprise a locking mechanism 18, wherein the locking mechanism 18 is operably coupled to the sign member 1, wherein operating the locking mechanism 18 governs movement of the sign member 1. In other words, the actuator assembly 7 may include a locking mechanism 18 configured to keep the sign member 1 in a locked position in a way that the sign member 1 can be retained in the stored position securely and does not move away from the side of the vehicle 4 when the vehicle 4 is traveling, even in a high-wind environment.

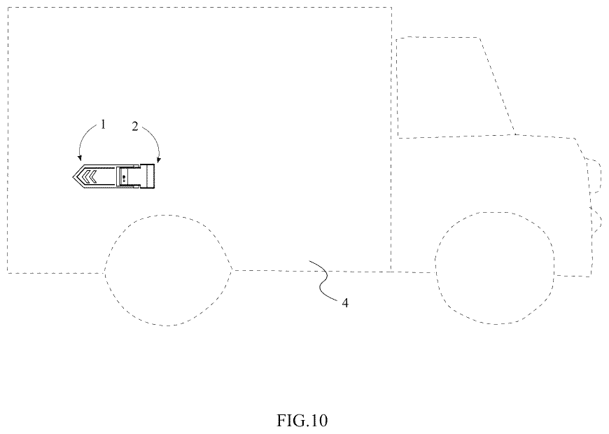

In reference to FIG. 10 and FIG. 11, a retracted mode and a deployed mode of a sign member 1 mounted to the vehicle 4 are illustrated respectively. In the preferred embodiment, the sign member 1 comprises a first surface 1b and a second surface 1c, wherein the first surface 1b is positioned opposite to the second surface 1c across the sign member 1. As seen in FIG. 10, the first surface 1b is oriented facing a lateral surface of the vehicle during the retracted mode. As seen in FIG. 11, the first surface 1b is oriented normally (90 degrees away) to the lateral surface of the vehicle during the deployed mode.

Although the invention has been explained in relation to its preferred embodiment, it is to be understood that many other possible modifications and variations can be made without departing from the spirit and scope of the invention as hereinafter claimed.

What is claimed is:

1. A vehicle sign device, comprising:
a sign member;
a mounting member;
a vehicle;
an actuator assembly;
the mounting member comprising a mounting surface and a casing;
the sign member being axially connected to the mounting member;
the mounting member being laterally mounted onto the vehicle along the mounting surface;
the actuator assembly being mounted within the casing; and
the actuator assembly being operably integrated between the mounting member and the sign member, wherein operating the actuator assembly governs axial rotation of the sign member between a retracted configuration and a deployed configuration.

2. The vehicle sign device of claim 1, wherein the actuator assembly comprising:
a rotational actuator;
a micro controller;
a power source;
a HID;
the rotational actuator and the HID being electronically coupled to the microcontroller;
the rotational actuator being mechanically connected to the sign member; and
the power source being electrically connected to the microcontroller;

3. The vehicle sign device of claim 2, the actuator assembly comprising:
a wireless communication module;
a computing device;
the wireless communication module being electronically coupled to the microcontroller; and
the wireless communication module being communicably coupled to the computing device.

4. The vehicle sign device of claim 2, comprising:
a sensor;
a dash camera;
the sensor and the dash camera being laterally integrated onto the mounting member; and
the sensor and the dash camera being electronically coupled to the microcontroller.

5. The vehicle sign device of claim 1, comprising:
a plurality of illuminating devices; and
the plurality of illuminating devices being integrated onto the sign member.

6. The vehicle sign device of claim 5, comprising:
the plurality of illuminating devices being arranged in the shape of arrows and border lines; and
progressively flashing the plurality of illuminating devices along the shape of arrows and borders.

7. The vehicle sign device of claim 1, comprising:
a caution label;
the caution label being laterally mounted onto a first surface of the sign member.

8. The vehicle sign device of claim 7, wherein the caution label is backlit.

9. The vehicle sign device of claim 1, the actuator assembly comprising:
a locking mechanism; and
the locking mechanism being operably coupled to the sign member, wherein operating the locking mechanism governs movement of the sign member.

10. The vehicle sign device of claim 1, wherein the sign member deploys and retracts in sync with the turn signal of the vehicle.

11. The vehicle sign device of claim 1, wherein the sign member is deployed manually.

12. The vehicle sign device of claim 1, the sign member comprising:
a first surface and a second surface, wherein the first surface is positioned opposite to the second surface across the sign member;
the first surface oriented facing a lateral surface of the vehicle during the retracted mode; and
the first surface oriented normal to the lateral surface of the vehicle during the deployed mode.

13. A vehicle sign device, comprising:
a sign member;
a mounting member;
an actuator assembly;
a vehicle;
a plurality of illuminating devices;
the mounting member comprising a mounting surface and a casing;
the sign member being axially connected to the mounting member;
the mounting member being laterally mounted onto the vehicle along the mounting surface;
the actuator assembly being mounted within the casing;
the actuator assembly being operably integrated between the mounting member and the sign member, wherein operating the actuator assembly governs axial rotation of the sign member between a retracted configuration and a deployed configuration; and
the plurality of illuminating devices being integrated onto the sign member.

14. The vehicle sign device of claim 13, wherein the actuator assembly comprising:
a rotational actuator;
a micro controller;
a power source;
a HID;
the rotational actuator and the HID being electronically coupled to the microcontroller;
the rotational actuator being mechanically connected to the sign member; and
the power source being electrically connected to the microcontroller.

15. The vehicle sign device of claim 14, the actuator assembly comprising:
a wireless communication module;
a computing device;
the wireless communication module being electronically coupled to the microcontroller; and
the wireless communication module being communicably coupled to the computing device.

16. The vehicle sign device of claim 14, comprising:
a sensor;
a dash camera;
the sensor and the dash camera being laterally integrated onto the mounting member; and
the sensor and the dash camera being electronically coupled to the microcontroller.

17. The vehicle sign device of claim 13, comprising:
a caution label;
the caution label being laterally mounted onto a first surface of the sign member.

18. The vehicle sign device of claim 17, wherein the caution label is backlit.

19. The vehicle sign device of claim 13, wherein the sign member deploys and retracts in sync with the turn signal of the vehicle.

20. The vehicle sign device of claim 13, wherein the sign member is deployed manually.
